(19) United States
(12) Patent Application Publication
(10) Pub. No.: US 2026/0355823 A1
(43) Pub. Date: Nov. 12, 2026

(54) METHOD FOR ADDITIVELY MANUFACTURING A WORKPIECE HAVING A CORE OF PURE COPPER OR A COPPER ALLOY

(71) Applicant: DMG MORI ULTRASONIC LASERTEC GMBH, Stipshausen (DE)

(72) Inventors: David Scheider, Kempten (DE); Martin Reisacher, Kempten (DE)

(73) Assignee: DMG Mori Ultrasonic Lasertec GmbH, Stipshausen (DE)

(21) Appl. No.: 19/115,518

(22) PCT Filed: Sep. 6, 2023
(86) PCT No.: PCT/EP2023/074458

§ 371 Date: Mar. 26, 2025

(30) Foreign Application Priority Data
Sep. 30, 2022 (DE) 10 2022 125 429.1

(51) Int. Cl. B22F 10/28; B22F 10/362; B22F 10/368; B22F 12/90; B33Y 10/00; B33Y 70/00

(52) U.S. Cl. CPC B22F 10/28; B22F 10/362; B22F 10/368; B22F 12/90; B33Y 10/00; B33Y 70/00; B22F 2301/052; B22F 2301/10; B22F 2301/15; B22F 2301/35

(57) ABSTRACT

A method for manufacturing a workpiece having a core of pure copper or a copper alloy by means of powder nozzle laser deposition welding is described. The method comprises: providing a core workpiece of pure copper or a copper alloy; providing a meltable metal powder; and applying the meltable metal powder to at least one portion of the core workpiece by means of powder nozzle laser deposition welding such that a plurality of metal layers are formed on the at least one portion of the core workpiece, wherein a controlling of a laser power, used for the powder nozzle laser deposition welding, is activated when a predetermined limit value is exceeded.

### CROSS REFERENCE TO RELATED APPLICATIONS

This application is a national stage of and claims priority to International Patent Application PCT/EP2023/074458, filed on Sep. 6, 2023, which claims priority to German patent application DE 10 2022 125 429.1, filed on Sep. 30, 2022, the entire disclosures of each of which are incorporated herein by reference.

### TECHNICAL FIELD

The disclosure relates to a method for manufacturing a workpiece having a core of pure copper or a copper alloy by means of powder nozzle laser deposition welding. By activating a controlling of the laser power, used for the powder nozzle laser deposition welding, when a predetermined limit value is exceeded, the method makes it possible to make the manufacturing process more stable and, in this way, to manufacture products of particularly high quality.

### BACKGROUND

It is an object of the disclosure to provide a method which makes it possible to additively manufacture components with a core of pure copper or a copper alloy in high quality. In particular, the method is intended to make possible a stable manufacturing process.

In the manufacture of tools, multi-material applications play a large role, in particular in cooling circuits. In die-casting tools, injection-molding tools or hot-forming tools, the removal of generated heat by a cooling medium is of decisive importance in the manufacture of products. An efficient cooling can, for example, shorten the process time and in this way make possible a higher throughput.

For heat dissipation or cooling, cooling channels are generally provided within the tool or mold insert, through which cooling channels a corresponding coolant can flow, in order to cool the material located in the tool. Copper or copper alloys are distinguished by good thermal conductivity and lend to such multi-material applications correspondingly good cooling properties.

Just like the products produced, the tools required for this also have complex geometrical shapes. The manufacture of such tools with cooling channels running therein is therefore complex and difficult.

The continuous coating of metal strips, including copper strips, by powder bed-based melting is known. For instance, WO 2018/192 865 A1 describes a method for applying a material layer to a metal strip, containing the steps: providing a metal strip, providing a meltable and/or sinterable powder, producing a layer of the meltable and/or sinterable powder on a portion of the moving metal strip while obtaining a powder bed, and heating at least a part of the powder bed with laser or electron radiation to at least the sintering or melting temperature of the powder while producing a material layer.

Basic materials or core components for producing tools are generally so-called volume components. In contrast to strips which offer a continuously flat surface, due to the complex geometry of tools, often only a small part of the surface is flat enough to form a powder bed at all. A metal layer with a constant layer thickness can, if at all, be produced only with difficulty in this way.

An additive manufacturing method for producing an injection mold with at least one coolant channel is known from DE 10 2004 040 929 A1. Here, DE 10 2004 040 929 A1 describes the cohesive application of a wear protection layer, preferably of steel, to a carrier material, preferably of copper or a copper alloy, by means of DMD methods.

The applicant has already described a method for manufacturing a workpiece with a cooling channel system in DE 10 2020 116 037 A1. Sections of the workpiece are formed by additive cohesive application of a build-up material. The introduction of a cavity into a respective workpiece section, and the formation of a connecting channel make it possible to produce a cooling channel system with a likewise complex shape running within the workpiece. Here, the build-up material can consist of copper or a copper alloy. In this method, too, the workpiece can be provided with a wear-resistant outer layer of tool steel.

A common feature of both methods is that a wear layer with a low layer thickness is applied to a comparatively large-dimensioned build-up material or carrier material. However, such a method cannot necessarily be applied to the production of workpieces having cores of copper or a copper alloy which are intended to be provided with more than one metal layer.

If the good thermal conductivity of pure copper or copper alloys is an advantage in the use in cooling circuits, then precisely this property offers a serious disadvantage in additive manufacturing, because, of course, heat is also dissipated into the copper core or the copper alloy core in the case of additive manufacturing.

If a high energy input is still necessary during the application of a first layer, then the temperature of the workpiece changes with an increase in metal layers formed which surround the core such that, under certain circumstances, overheating can occur during the manufacturing process. The temperature of the workpiece during the manufacturing process can, if appropriate, change rapidly and can adversely influence the stability of the manufacturing process and thus also the product quality.

A further disadvantage is the high degree of reflection in the infrared range, in particular of pure copper, which leads to poor energy input in the case of laser-based methods with, at the same time, high power consumption for melting.

### SUMMARY

It would therefore be desirable to be able to overcome the abovementioned disadvantages and to be able to provide a stable additive manufacturing method which makes it possible to manufacture components with a core of pure copper or a copper alloy in high quality.

The abovementioned object is achieved by the features of an independent claim. The dependent claims are directed to variations of the disclosure.

A method according to the disclosure for manufacturing a workpiece having a core of pure copper or a copper alloy by means of powder nozzle laser deposition welding comprises firstly the step a) of providing a core workpiece of pure copper or a copper alloy.

The term core workpiece is to be understood herein as a basic material or basic component which is coated with a plurality of metal layers in accordance with the method described herein such that the core workpiece forms the inner core of the finished workpiece. The size and shape of the core workpiece is restricted only insofar as it is a volume component. A volume component can be, for example, a cube, a cuboid, a pyramid or a rod, or can also have a more complex three-dimensional shape which will be oriented according to the complex shape of the workpiece to be manufactured. However, a volume component within the meaning of the disclosure is not a strip or a similarly planar component.

As already mentioned, powder bed-based additive manufacturing methods are disadvantageous in the processing of volume components. By contrast, “powder nozzle laser build-up welding” is an additive manufacturing method or else a 3D printing technology according to the principle of directed energy deposition (DED).

In the DED method, metal powder is forced through a feed nozzle (powder nozzle), for example an annular gap nozzle, and is melted or welded to the basic material by a laser to form the so-called melt pool. Both the laser and the feed nozzle are generally attached to a multi-axis machine tool or a robot arm. The process typically takes place under a local protective gas atmosphere or in a hermetically sealed chamber under protective gas in order to better control the material properties and to protect the material from undesired oxidation.

Pure copper has a very high thermal conductivity of 400 Wm⁻¹K⁻¹ at 20 °C and thus offers a very good temperature dissipation in the component. Due to the faster heat dissipation, the cooling performance can thus be improved.

The term “pure copper”, as used herein, refers to copper which is present in elemental form and can contain minor impurities. Preferably, the total amount of impurities is not more than 1 weight percent, particularly preferably not more than 0.1 weight percent and most particularly preferably not more than 0.01 weight percent based on the total mass of copper.

As an alternative to pure copper, a copper alloy can also be used in the method according to the disclosure. According to the disclosure, the composition of the copper alloy is not limited in principle. In contrast to pure copper, copper alloys generally have a lower thermal conductivity, so that a high copper content is advantageous, wherein the term “high” is generally dependent on the type and composition of the alloy. In any case, the thermal conductivity of the copper alloy should not fall below a lower limit of 65 Wm⁻¹K⁻¹ at 20 °C, preferably 166 Wm⁻¹K⁻¹ at 20 °C. In this way, although the temperature dissipation in the component is reduced, it is still improved compared to materials without copper content.

The use of copper-tin alloys (bronze), copper-aluminum alloys, in particular aluminum bronzes, copper-zinc alloys (brass), copper-nickel alloys, copper-nickel-zinc alloys, copper-tin-zinc alloys, copper-manganese alloys, low-alloy copper alloys or copper-lead-tin alloys is conceivable.

At this point, it is noted that the alloys described above are not restricted to two- or three-material alloys, but may also contain further alloy components or additives, provided that the stated lower limit of the thermal conductivity is not undershot. However, copper aluminum alloys with an aluminum content of 1 to 10%, for example CuAl1 or CuAl10, are preferably used. Unless stated otherwise, data in % relate to percent by mass herein.

According to the disclosure, the method further comprises the step b) of providing a meltable metal powder. According to the disclosure, the composition and particle size of the meltable metal powder is not limited in principle, provided that it can be processed by means of powder nozzle laser deposition welding.

In an example, the meltable metal powder can comprise tool steel. In this way, a multi-material workpiece of tool steel and pure copper or copper alloy can be produced. The pure copper or the copper alloy form the core, which is encased by layers of tool steel.

Alternatively, according to a further example, the meltable metal powder can also comprise a nickel-based alloy. The term nickel-based alloy refers herein to an alloy whose main constituent is nickel and which contains at least one other alloy component (another element). Nickel-based alloys are, for example, nickel-copper, nickel-iron, nickel-iron-chromium, nickel-chromium, nickel-molybdenum-chromium, nickel-chromium-cobalt, low-alloy nickel alloys (with a nickel content of up to 99.9%) and other multi-material alloys. Examples are Alloy 718 (NiCr19NbMo), or also Alloy 600 (NiCr15Fe). In this way, a multi-material workpiece of nickel-based alloy and pure copper or copper alloy can be produced. The pure copper or the copper alloy form the core, which is encased by layers of nickel-based alloy.

According to the disclosure, the method further comprises the step c) of applying the meltable metal powder to at least one portion of the core workpiece by means of powder nozzle laser deposition welding such that a plurality of metal layers are formed on the at least one portion of the core workpiece, wherein a controlling of a laser power, used for the powder nozzle laser deposition welding, is activated when a predetermined limit value is exceeded.

As already explained, the coating process is complex in the case of volume components of copper or copper alloys. With an increase in metal layers formed which surround the core workpiece, the temperature of the workpiece, i.e. of the core workpiece including the metal layers already formed, can change rapidly and overheating of the workpiece can occur during the manufacturing process. This can adversely influence the stability of the manufacturing process and thus also the product quality.

The cause is the heating of the metal powder or of the melt pool during the welding. This then in turn heats the core workpiece by means of heat conduction. As a result of the encasing of the core workpiece in the at least one portion, heat from the core workpiece can no longer be readily dissipated to the surroundings. The core workpiece in turn heats up and the temperature in the workpiece can rise rapidly, with the result that overheating is imminent. The increase in the absorption coefficient with the temperature additionally contributes to the temperature increase in the core workpiece.

According to the disclosure, these effects can be stabilized by activating a controlling of the laser power when a predetermined limit value is exceeded. In this case, the laser power can be controlled, for example, in a range from 100 W to 2500 W, preferably 100 to 2000 W, particularly preferably 100 to 1500 W, with a maximum control speed of 50 W/s or more, preferably 100 W/s or more.

Such a controlling of the laser power in DED-based methods has hitherto not been known in this connection. This question has not yet arisen either. Only the application of a plurality of metal layers, the complex workpiece geometry in conjunction with the difficult properties of pure copper and copper alloys for the processing now made such considerations necessary. In this case, it is initially immaterial how the controlling of the laser power ultimately takes place; in order to stabilize the mentioned disadvantageous effects, it is important that the controlling of the laser power is activated at all during the powder nozzle laser deposition welding when a predetermined limit value is exceeded, in order to avoid overheating of the workpiece.

According to an example, the predetermined limit value can be a predetermined number of metal layers formed. Thus, the controlling of the laser power can be activated, for example, after the formation of a first, second or third metal layer. The predetermined number of metal layers will in this case certainly depend on the layer thickness of the first metal layer, and alternatively or additionally also on the geometry and size of the volume component and/or on the initial laser power. Preferably, however, the controlling of the laser power is activated after the formation of a first metal layer, in order to make possible a high stability of the manufacturing process.

According to an example, the predetermined limit value can also be a maximum temperature of the workpiece during the powder nozzle laser deposition welding. The maximum temperature is in this case not limited in principle, since it will likewise certainly depend on the layer thickness of the metal layers formed, and alternatively or additionally also on the geometry and size of the volume component and/or on the initial laser power. Preferably, the maximum temperature can be in a range from 200 °C to 700 °C, particularly preferably in a range from 300 °C to 600 °C, very particularly preferably at 400 °C. The maximum temperature can also correspond to a preheating temperature described herein.

According to an example, the method can then further comprise: monitoring a temperature of the workpiece during the powder nozzle laser deposition welding by means of a thermal imaging camera.

Thus, preferably at the beginning of the powder nozzle laser deposition welding in step c) of the method according to the disclosure, a temperature of the workpiece can be monitored in narrow-mesh intervals of, for example, 1 s to 10 s, in predetermined sampling rates or also continuously by means of a thermal imaging camera. When the previously defined maximum temperature is exceeded, the controlling of the laser power can then be activated. For this purpose, the thermal imaging camera is particularly advantageously coupled to the controller of the laser and the activation of the controlling takes place automatically via feedback of the temperature value of the thermal imaging camera to the controller of the laser. Thus, when the predetermined maximum temperature is exceeded, the laser power can, for example, be automatically reduced.

According to the disclosure, the manner in which the controlling of the laser power takes place is not limited in principle, as long as overheating of the workpiece during the powder nozzle laser deposition welding can be avoided.

According to an example, however, the laser power can be controlled as a function of a melt pool size. The melt pool formed during the powder nozzle laser deposition welding correlates directly with the laser power used. If the melt pool is large, for example 17 mm², the laser power is high. If the laser power is then reduced, this is also reflected in a reduction of the size of the melt pool. In order to control the laser power after activation, for example, a characteristic curve can be stored in the controller of the laser, which connects a laser power with a melt pool size. Alternatively or additionally, the laser power can also be controlled on the basis of a comparison with a predetermined target melt pool size. The target melt pool size can in this case be predetermined in accordance with the geometry and size of the core workpiece, and the number and thickness of the metal layers to be applied. The target melt pool size can be, for example, 6 to 10 mm², preferably 7 to 9 mm².

According to an example, the melt pool size can be determined by means of a melt pool camera. Such a melt pool camera can, for example, be integrated into the laser optics or coupled thereto. The laser power can then be automatically controlled via feedback of the actual value measured with the melt pool camera to the controller of the laser.

According to an example, the controlling of the laser power as a function of the melt pool size can comprise: determining at least one actual melt pool size and controlling the laser power on the basis of a comparison of the at least one actual melt pool size with the predetermined target melt pool size. For this purpose, the melt pool size can, for example, be measured in narrow-mesh intervals of, for example, 1 s to 10 s, be monitored in predetermined sampling rates or also continuously by means of the melt pool camera.

According to the disclosure, the wavelength of the laser radiation with which the powder nozzle deposition welding is carried out is not limited in principle. According to an example, the powder nozzle laser deposition welding can, however, be carried out with laser radiation having a wavelength in the range of 380 nm to 560 nm or a wavelength in the range of 780 nm to 1400 nm, for example at 450 nm or 1030 nm.

According to the disclosure, the laser used is also not limited in principle; for example, a laser usual for DED-based methods can be used, for instance a diode, CO₂ or fiber laser.

As already explained, the good thermal conductivity of pure copper or copper alloys is an advantage in the use in cooling circuits, but offers a serious disadvantage in additive manufacturing, since, of course, heat is also dissipated into the copper core or the copper alloy core in the case of additive manufacturing. When applying a first metal layer, the high thermal conductivity makes the welding process more difficult as a result of the rapid dissipation of the heat into the core workpiece owing to the direct contact between metal layer and core workpiece. This can lead to a low melt bath stability. In the case of copper alloys, the temperature dissipation from the melt bath is likewise present, but less pronounced than in the case of pure copper owing to the reduced thermal conductivity.

This effect can make the application of a first metal layer more difficult. In order to stabilize this effect, according to an example, the applying of the meltable metal powder to the at least one portion of the core workpiece by means of powder nozzle laser deposition welding can comprise: applying a first metal layer at a maximum laser power and with low powder mass flow.

The powder mass flow indicates how many grams of metal powder per minute are forced through the feed nozzle. The greater the powder mass flow, the more metal powder is forced through the feed nozzle. When applying the first metal layer, the metal powder has not yet been heated by the welding process and can lead to additional cooling and thus destabilization of the melt pool. Therefore, a low powder mass flow is advantageously used when applying the first metal layer.

For example, when applying the first metal layer, the maximum laser power can be in a range of 2000 W to 2500 W and the powder mass flow can be in a range of 4 to 6 g/min. In particular, when using laser radiation in the infrared (IR) range, this is advantageous since pure copper has a high degree of reflection in the IR range, which makes the input of energy more difficult.

Alternatively, the above-described disadvantageous effect when forming the first metal layer can also be stabilized by preheating the core workpiece by reducing the dissipation of the heat into the core workpiece.

According to an example, the method can therefore additionally comprise, before forming the metal layers in step c): preheating the core workpiece to a preheating temperature of 150 °C or higher, preferably 250 °C or higher, particularly preferably 400 °C or higher.

According to an example, the preheating of the core workpiece before forming the metal layers in step c) can be carried out by means of laser radiation, induction or an external furnace. Particularly preferably, the preheating can be carried out by means of laser radiation having a wavelength in the blue to green range of 380 nm to 560 nm or a wavelength in the infrared range of 780 nm to 1400 nm, for example at 450 nm or 1030 nm. In contrast to laser radiation in the infrared range, laser radiation in the blue to green range has the advantage during preheating that the absorption behavior of pure copper is better in the case of laser radiation having a wavelength in the blue to green range. In this case, the absorption rate is 44 percent-compared to 2 percent in the case of infrared light.

In order to make the additive manufacturing method even more stable and to further increase the product quality, according to an example, the applying of the meltable metal powder to the at least one portion of the core workpiece by means of powder nozzle laser deposition welding can comprise the following two stages:
i) applying one or more metal layers while controlling the laser power at low powder mass flow; and
ii) applying one or more further metal layers while controlling the laser power at high powder mass flow.

In stage i), the focus here is on a maximum mixing between the pure copper or the copper alloy of the core workpiece and the metal powder. This serves, in particular for producing a load-bearing cohesive connection between the core workpiece and metal layers. Likewise, as already described, the overheating of the workpiece is to be avoided by the controlling.

In stage ii), by contrast, the focus then is on a maximum material application, and likewise on the already described avoidance of the overheating of the workpiece.

In stage i), the laser power can be controlled, for example, in a range of 2500 W to 100 W (upper and lower power limit) with a control speed of 50 W/s or more and the powder mass flow can be in a range of 4 to 6 g/min.

In step ii), the laser power can be controlled, for example, in a range of 1500 W to 100 W with a control speed of 50 W/s or more and the powder mass flow can be in a range of 8 to 12 g/min.

In combination with the already described applying of a first metal layer at a maximum laser power and with low powder mass flow, a three-stage method can also be realized. In the first stage of the applying of the first metal layer at maximum laser power and with low powder mass flow, the focus is on the preheating of the core workpiece, the increase of the degree of absorption in the core workpiece and the already described stabilization of the melt pool.

As likewise already described, the preheating of the core workpiece can also be carried out alternatively by means of laser radiation, induction or an external furnace.

Optionally, according to an example, the method can additionally comprise, before step c): applying a buffer layer of a copper alloy to the at least one portion of the core workpiece. In this way, for example, the good thermal conductivity of pure copper in the core workpiece can be obtained, and the advantages of the reduced thermal conductivity and of the reduced degree of reflection in the infrared range of copper alloys can be utilized for the manufacturing method.

According to an example, the buffer layer can consist of a copper aluminum alloy, wherein the copper aluminum alloy can contain aluminum in a proportion of 1% to 10%.

With the method described herein, in principle volume components with a core of copper or a copper alloy can be manufactured, in particular volume components of complex geometry. If the workpiece is a tool, as described in the introduction, the method can additionally comprise step d): drilling one or more cooling channels into the core workpiece.

Furthermore, it is noted that the method described herein can be part of a hybrid method which can additionally comprise, for example, material-removing and shaping steps in order to obtain an end product of desired geometry and function.

### BRIEF DESCRIPTION OF THE FIGURES

FIG. 1 shows a flow diagram of an example of a method for manufacturing a workpiece having a core of pure copper or a copper alloy by means of powder nozzle laser deposition welding.

FIG. 2 shows a control circuit for illustrating a control of a laser power used for the powder nozzle laser deposition welding according to an example.

FIG. 3 shows a flow diagram of a method for manufacturing a workpiece having a core of pure copper or a copper alloy by means of powder nozzle laser deposition welding according to an example with preheating of the core workpiece.

FIG. 4 shows a flow diagram of a method for manufacturing a workpiece having a core of pure copper or a copper alloy by means of powder nozzle laser deposition welding according to an example with two-stage metal layer deposition.

FIG. 5 schematically shows an example system suitable for carrying out the method.

FIG. 6 schematically shows the manufacture of a mandrel according to an example of the method.

FIGS. 7 a-e show photographs of the manufacture of a mandrel according to a further example of the method.

FIGS. 8 a-d show profiles of the process parameters as a function of time during the manufacture of the mandrel according to the example from FIGS. 7 a-e.

FIG. 9 shows a connection between the profile of the laser power and the melt pool size as a function of time in the first metal layer during the manufacture of the mandrel according to the example from FIGS. 7 a-e.

### DETAILED DESCRIPTION

Examples of the present disclosure are described in detail below with reference to the attached figures. Identical or similar elements in the figures can be denoted here by the same reference numerals, but sometimes also by different reference numerals.

It should be emphasized that the present disclosure is however in no way limited or restricted to the examples described below and the features thereof, but rather further comprises modifications of the example, in particular those which are comprised by modification of the features of the described examples or by combination of individual or a plurality of features of the described examples within the scope of the claims.

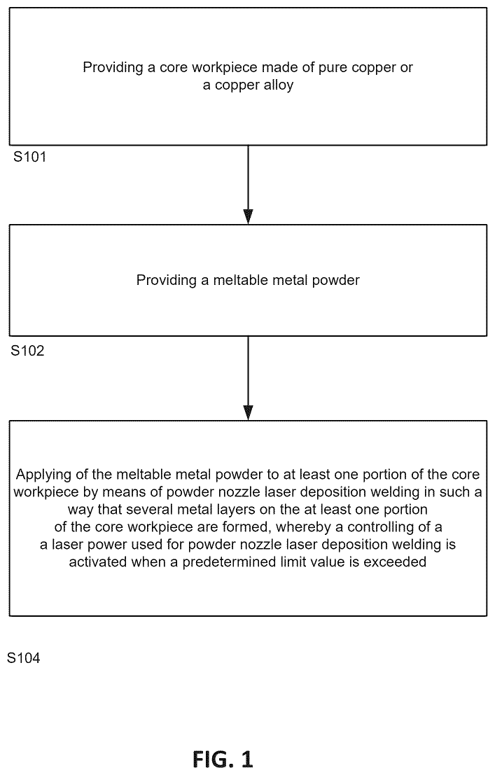

Referring to FIG. 1, a flow diagram of an example of a method for manufacturing a workpiece having a core of pure copper or a copper alloy by means of powder nozzle laser deposition welding is shown. In step S101, firstly a core workpiece of pure copper or a copper alloy is provided. As already described, the copper alloy can preferably be a copper aluminum alloy with an aluminum content of 1 to 10%, for example CuAl1 or CuAl10.

In step S102, a meltable metal powder is provided. According to an example, the meltable metal powder can comprise tool steel. Alternatively, according to an example, the meltable metal powder can also comprise a nickel-based alloy.

In step S104, finally the meltable metal powder is applied to at least one portion of the core workpiece by means of powder nozzle laser deposition welding such that a plurality of metal layers are formed on the at least one portion of the core workpiece, wherein a controlling of a laser power, used for the powder nozzle laser deposition welding, is activated when a predetermined limit value is exceeded. In this case, the laser power can be controlled, for example, in a range of 100 W to 2500 W, preferably 100 to 2000 W, particularly preferably 100 to 1500 W, with a maximum control speed of 50 W/s or more, preferably 100 W/s or more.

As already explained, the coating process is complex in the case of volume components of copper or copper alloys. For the reasons already described, therefore, a controlling of the laser power during the powder nozzle deposition welding is used for the first time.

According to an example, the predetermined limit value can be a predetermined number of metal layers formed, as already described.

Alternatively, according to an example, the predetermined limit value can also be a maximum temperature of the workpiece during the powder nozzle laser deposition welding. The method can then comprise monitoring a temperature of the workpiece during the powder nozzle laser deposition welding by means of a thermal imaging camera.

Thus, preferably at the beginning of the powder nozzle laser deposition welding, a temperature of the workpiece can be monitored in narrow-mesh intervals of, for example, 1 s to 10 s, in predetermined sampling rates or also continuously by means of a thermal imaging camera. When the previously defined maximum temperature is exceeded, the controlling of the laser power can then be activated. For this purpose, the thermal imaging camera is coupled to the controller of the laser and the activation of the controlling takes place automatically via a feedback of the temperature value of the thermal imaging camera to the controller of the laser. Thus, when the predetermined maximum temperature is exceeded, the laser power can, for example, be automatically reduced.

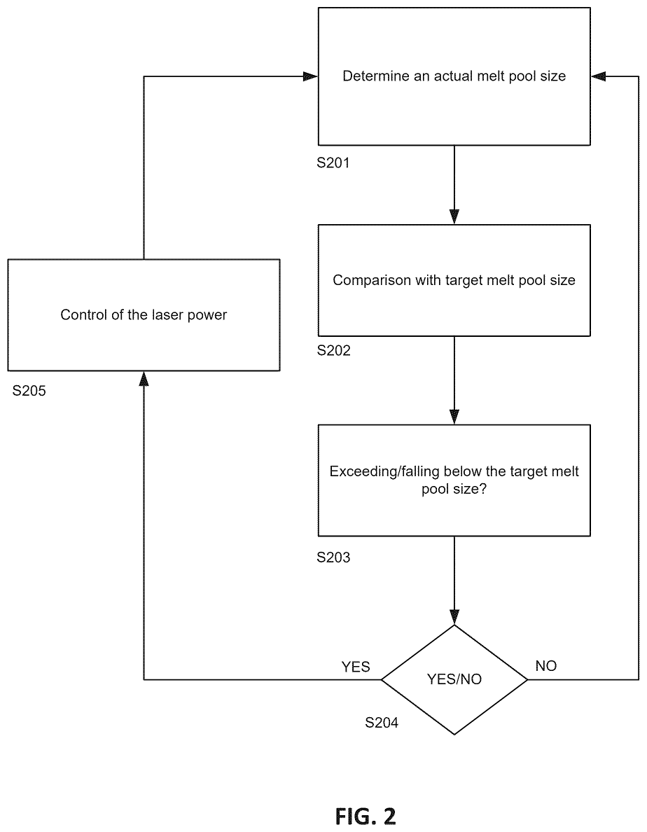

Referring to FIG. 2, a control circuit for illustrating a controlling of a laser power used for the powder nozzle laser deposition welding according to an example is shown.

In step S201, first an actual melt pool size is determined, preferably by use of a melt pool camera. The melt pool camera can, for example, be integrated into the laser optics or coupled thereto.

In step S202, the measured actual melt pool size is then compared with a predetermined target melt pool size.

On the basis of predetermined permitted deviations, for example ±0.5 mm², it can then be determined in step S203 whether the target melt pool size is exceeded or fallen below and whether the laser power has to be controlled accordingly.

If there is an overshoot/undershoot in step S204, the controlling of the laser power is initiated in step S205. If there is no overshoot/undershoot, the cycle begins from the start.

The control circuit described can take place automatically via feedback of the actual value measured with the melt pool camera to the controller of the laser.

Depending on the frequency of the determination of the actual melt pool size, the cycle can correspondingly be run through, for example, in narrow-mesh intervals of, for example, 1 s to 10 s.

As already explained, the high thermal conductivity of pure copper or copper alloys is an advantage in the use in cooling circuits, but offers a serious disadvantage in additive manufacturing, since, of course, heat is also dissipated into the copper core or the copper alloy core in the case of additive manufacturing. When applying a first metal layer, the high thermal conductivity makes the welding process more difficult as a result of the rapid dissipation of the heat into the core workpiece owing to the direct contact between metal layer and core workpiece. This can lead to a low melt pool stability. In the case of copper alloys, the temperature dissipation from the melt bath is likewise present, but less pronounced than in the case of pure copper owing to the reduced thermal conductivity.

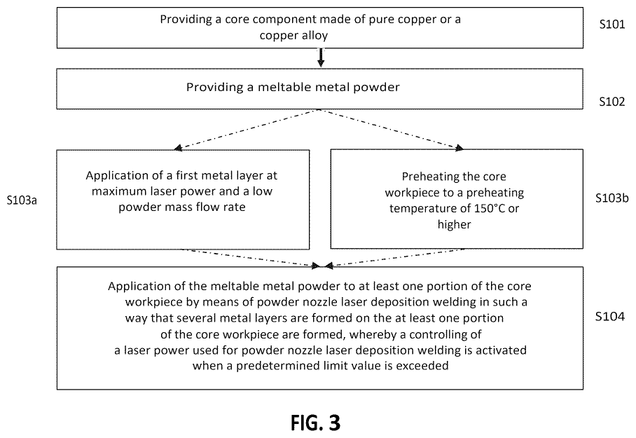

This effect can make the application of a first metal layer more difficult. In order to stabilize this effect, according to an example, the applying of the meltable metal powder to the at least one portion of the core workpiece by powder nozzle laser deposition welding can comprise: applying a first metal layer at a maximum laser power and with low powder mass flow. This is shown in step S103 a in FIG. 3. For example, when applying the first metal layer, the maximum laser power can be in a range of 2000 W to 2500 W and the powder mass flow can be in a range of 4 to 6 g/min. When using laser radiation in the infrared (IR) range, this is advantageous because pure copper has a high degree of reflection in the IR range, which makes the input of energy more difficult.

Alternatively, the above-described disadvantageous effect when forming the first metal layer can also be stabilized by preheating the core workpiece. By reducing the dissipation of the heat into the core workpiece. According to an example, the method can therefore additionally comprise, before forming the metal layers in step c): preheating the core workpiece to a preheating temperature of 150 °C or higher, preferably 250 °C or higher, particularly preferably 400 °C or higher. This is shown in step S103 b in FIG. 3.

According to an example, the preheating of the core workpiece before forming the metal layers in step S104 can be carried out by laser radiation, induction, or an external furnace. In an example, the preheating can be carried out by means of laser radiation having a wavelength in the blue to green range of 380 nm to 560 nm or a wavelength in the infrared range of 780 nm to 1400 nm, for example at 450 nm or 1030 nm. In contrast to laser radiation in the infrared range, laser radiation in the blue to green range has the advantage during preheating that the absorption behavior of pure copper is better in the case of laser radiation having a wavelength in the blue to green range. In this case, the absorption rate is 44 percent-compared to 2 percent in the case of infrared light.

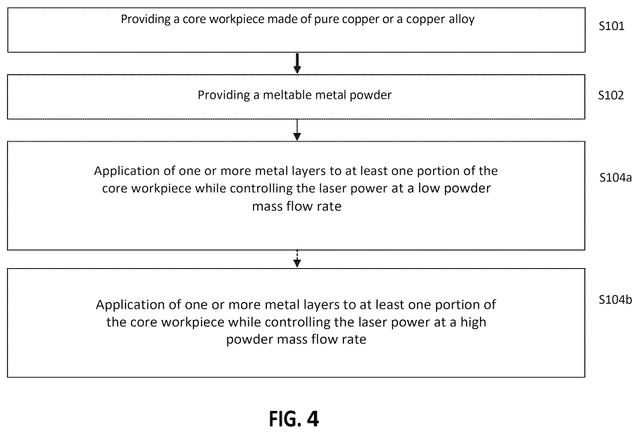

Referring to FIG. 4, a flow diagram of a method for manufacturing a workpiece having a core of pure copper or a copper alloy by powder nozzle laser deposition welding according to an example with two-stage metal layer deposition is shown. In order to make the additive manufacturing method even more stable and to further increase the product quality, according to an example, the applying of the meltable metal powder to the at least one portion of the core workpiece by powder nozzle laser deposition welding can comprise the following two stages:
stage S104a applying one or more metal layers while controlling the laser power at low powder mass flow; and
stage S104b applying one or more further metal layers while controlling the laser power at high powder mass flow.

In stage S104a, the focus here is on a maximum mixing between the pure copper or the copper alloy of the core workpiece and the metal powder. This can serve to produce a load-bearing cohesive connection between the core workpiece and metal layers. Likewise, as already described, the overheating of the workpiece is to be avoided by the controlling. Here, the laser power can be controlled, for example, in a range of 2500 W to 100 W (upper and lower power limit) with a control speed of 50 W/s or more and the powder mass flow can be in a range of 4 to 6 g/min.

In stage S104b, by contrast, the focus then is on a maximum material application, and likewise on the already described avoidance of the overheating of the workpiece. Here, the laser power can be controlled, for example, in a range of 1500 W to 100 W with a control speed of 50 W/s or more and the powder mass flow can be in a range of 8 to 12 g/min.

In combination with steps S103 a or S103 b from FIG. 3, a three-stage method can also be realized.

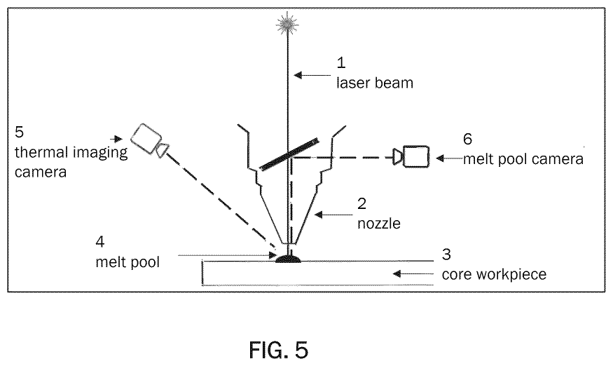

Referring to FIG. 5, an example of a system suitable for carrying out the method is shown.

The system contains a powder nozzle 2 to produce a powder mass flow of meltable metal powder. The powder nozzle is designed as an annular gap nozzle, through the center of which a laser beam 1 is guided. A melt pool camera 6 is integrated into a laser optics. By means of a mirror, the size of the melt pool 4 produced on the core workpiece 3 can be determined during the deposition welding by the melt pool camera. A temperature of the workpiece can be monitored by the thermal imaging camera 5 present. As already described, for example a diode, CO₂ or a fiber laser can be used for the powder nozzle laser deposition welding. The wavelength of the laser radiation 1 can be in the range of 380 nm to 560 nm or in the range of 780 nm to 1400 nm, for example at 450 nm or 1030 nm.

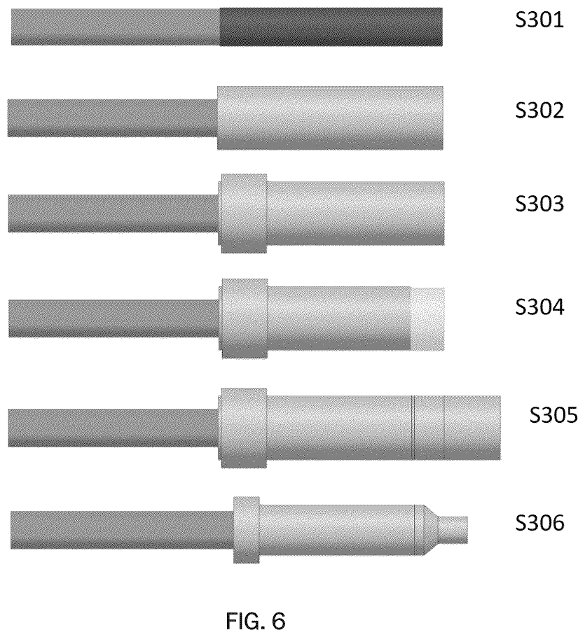

FIG. 6 schematically shows the manufacture of a mandrel according to an example of the method.

In this example, the core workpiece is a rod of pure copper. In step S301, optionally a buffer layer of a copper alloy can be applied to at least one portion of the core workpiece before the first metal layer of tool steel is formed in step S302. According to an example, the buffer layer can, as already described, comprise a copper aluminum alloy which contains 1% (CuAl1) to 10% (CuAl10) aluminum.

As can be seen based on steps S302 and S303, in this example a total of a plurality of metal layers are formed on the portion of the core workpiece, in each case one or more metal layers of different size. The size of the metal layer formed in each case on the portion of the core workpiece can in this case be controlled, for example, via a feed rate at which the core workpiece is moved, and/or via a movement of the powder nozzle over the core workpiece, and via the powder mass flow. Additional rotation about the longitudinal axis makes possible the sheathing of the core workpiece with the respective metal layer.

The metal layers formed can, as shown, then be finished by cutting off the tip in step S304, building up a cover in step S305 and turning in step S306. Finally, a further channel is drilled into the rod-shaped core workpiece to finish the mandrel (not shown).

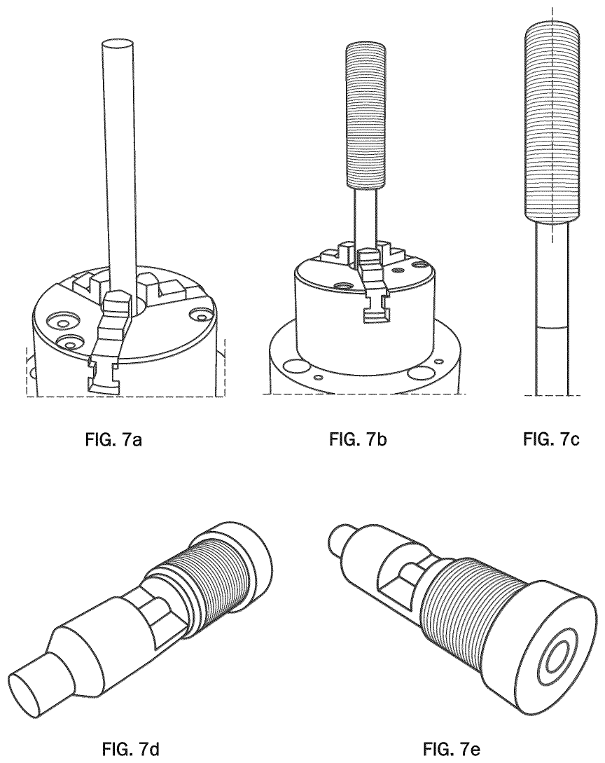

FIGS. 7a-e show photographs of the manufacture of a corresponding mandrel according to an example. FIG. 7a shows the copper rod. The copper rod has a diameter of 12 mm and a length of 100 mm. However, the copper rod can also have a diameter of, for example, 8 or 10 mm. FIG. 7b shows the copper rod after coating with tool steel; in FIG. 7c, the ground plane is indicated by the dashed line drawn in. FIGS. 7d and e show the exemplary workpiece after finishing by turning and drilling. The cohesive connection of copper core and tool steel can be seen in the ground diagram.

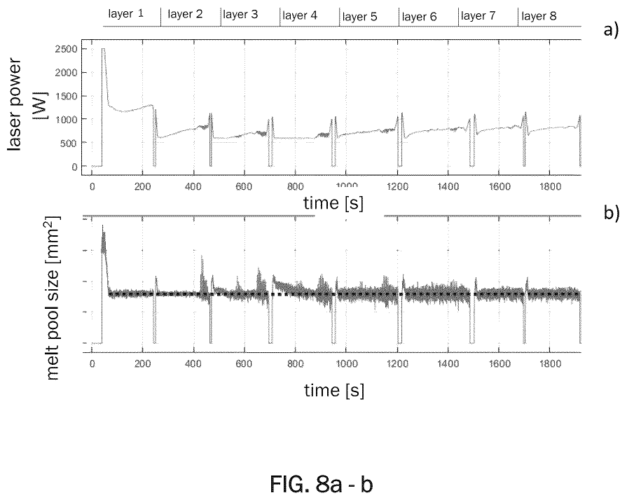

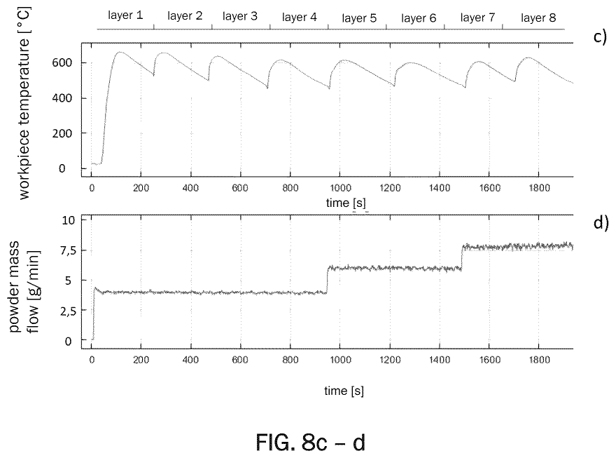

FIGS. 8a to 8d show the time-dependent profile of the process parameters during the deposition welding in the example from FIG. 7. The effect of the controlling of the laser power described herein can be seen on the basis of the profiles of the associated process parameters in FIGS. 8a to d. The corner data of the example are listed again below:
fastening the copper rod on a machine table, pure copper rod with a diameter of 12 mm and a length of 100 mm;
switching on the laser beam source, IR laser at a wavelength in the range of 900-1080 nm, and switching on the powder conveyor for conveying tool steel powder;
rotationally moving the copper rod and preheating the copper rod by applying the first tool steel layer to a portion of the copper rod at maximum laser power of 2500 W and with low powder mass flow of 4 g/min, in order to produce a layer thickness of approximately 0.3 mm.
After reaching the limit value, a maximum temperature of 400 °C in the workpiece: automatically activating the laser power controlling based on the following target melt pool size and the following controlling limits for the laser power:
   target melt pool size: 8.6 mm²
   controlling limits: 100-1500 W (power which may not be undershot or exceeded during the controlling)
   maximum control speed: 100 W/s (maximum permissible power change per time for controlling the reaction time of the system)
increasing the powder mass flow to 8 to 12 g/min and the feed rate after formation of a plurality of metal layers for increasing the material application.

FIGS. 8a and b show the automatically controlled laser power as a function of the measured melt pool size as a function of time. The dashed line indicates the target melt pool size. The correlation between overshoot/undershoot of the target melt pool size and the automatic controlling of the laser power resulting therefrom can be seen here.

FIGS. 8c and d show the measured component temperature and the powder mass flow as a function of time. The term “layer” corresponds to the term “layer”. Layer 1 thus means first metal layer.

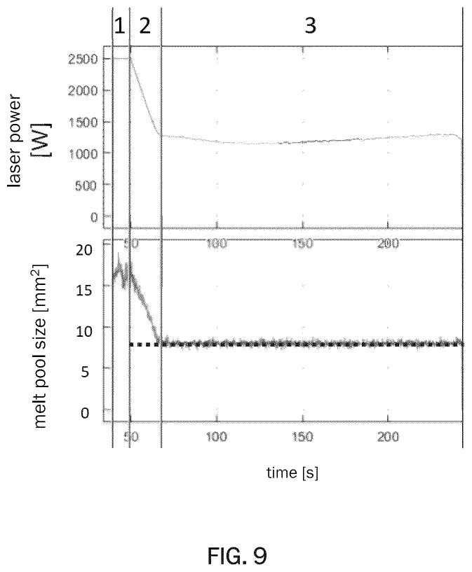

FIG. 9 shows a connection between the profile of the laser power and the melt pool size as a function of time in the first metal layer.
Stage 1: power control not active, deposition welding at maximum power→large melt pool (here approximately 17.5 mm²). The focus is on the preheating of the core workpiece→increase of the degree of absorption in the core workpiece→stabilization of the melt pool
Stage 2: power control active at workpiece temperature of 400 °C, large difference between actual and target melt pool size→maximum reduction of the laser power (here: 100 W/s)→melt pool size drops to target melt pool size (8.6 mm², dashed line). Prevention of the overheating of the core workpiece by power control→focus on maximum mixing between copper and tool steel.
Stage 3: power control active, small difference between actual and target melt pool size→minimum adjustment of the laser power. Prevention of the overheating of the core workpiece by power control→focus on maximum material application.

REFERENCE NUMBERS

| | |
|---|---|
| 1 | Laser beam |
| 2 | Powder nozzle |
| 3 | Core workpiece |
| 4 | Melt pool |
| 5 | Thermal imaging camera |
| 6 | Melt pool camera |

What is claimed is:

1. A method for manufacturing a workpiece having a core of pure copper or a copper alloy by means of powder nozzle laser deposition welding, the method comprising:
a) providing a core workpiece of pure copper or a copper alloy;
b) providing a meltable metal powder; and
c) applying the meltable metal powder to at least one portion of the core workpiece by means of powder nozzle laser deposition welding such that a plurality of metal layers are formed on the at least one portion of the core workpiece, wherein a controlling of a laser power, used for the powder nozzle laser deposition welding, is activated when a predetermined limit value is exceeded.

2. The method according to claim 1, wherein the predetermined limit value is a maximum temperature of the workpiece during the powder nozzle laser deposition welding.

3. The method according to claim 2, further comprising: determining a temperature of the workpiece during the powder nozzle laser deposition welding by means of a thermal imaging camera.

4. The method according to claim 1, wherein the predetermined limit value is a predetermined number of metal layers formed.

5. The method according to claim 1, wherein the laser power is controlled as a function of a melt pool size.

6. The method according to claim 5, wherein the controlling of the laser power as a function of the melt pool size comprises: determining at least one actual melt pool size and controlling the laser power on the basis of a comparison of the at least one actual melt pool size with a predetermined target melt pool size.

7. The method according to claim 5, wherein the melt pool size is determined by use of a melt pool camera.

8. The method according to claim 1, wherein the powder nozzle laser deposition welding is carried out with laser radiation having a wavelength in a range of 380 nm to 560 nm or a wavelength in a range of 780 nm to 1400 nm.

9. The method according to claim 1, wherein the applying of the meltable metal powder to the at least one portion of the core workpiece by means of powder nozzle laser deposition welding comprises: applying a first metal layer at a maximum laser power and with low powder mass flow.

10. The method according to claim 1, further comprising, before the applying the meltable metal powder to at least one portion of the core workpiece: preheating the core workpiece to a preheating temperature of 150 °C or higher.

11. The method according to claim 10, wherein the preheating is carried out by means of laser radiation, induction or an external furnace.

12. The method according to claim 11, wherein the preheating is carried out by means of laser radiation having a wavelength in a range of 380 nm to 560 nm or a wavelength in a range of 780 nm to 1400 nm.

13. The method according to claim 1, wherein the applying of the meltable metal powder to the at least one portion of the core workpiece by means of powder nozzle laser deposition welding comprises:
i) applying one or more metal layers while controlling the laser power at low powder mass flow; and
ii) applying one or more further metal layers while controlling the laser power at high powder mass flow.

14. The method according to claim 1, further comprising, before the applying the meltable metal powder to at least one portion of the core workpiece: applying a buffer layer of a copper alloy to the at least one portion of the core workpiece.

15. The method according to claim 14, wherein the copper alloy is a copper aluminium alloy with aluminium in a proportion of 1% to 10%.

16. The method according to claim 1, wherein the meltable metal powder comprises tool steel.

17. The method according to claim 1, wherein the meltable metal powder comprises a nickel-based alloy.

18. The method according to claim 1, further comprising d): drilling one or more cooling channels into the core workpiece.
